(19) United States
(12) Patent Application Publication
(10) Pub. No.: US 2026/0221552 A1
(43) Pub. Date: Jul. 30, 2026

(54) MANAGEMENT OF THERMAL EVENT BY-PRODUCTS IN A BATTERY PACK

(71) Applicant: Toyota Motor Engineering & Manufacturing North America, Inc., Plano, TX (US)

(72) Inventors: David Richard Eilken, Ann Arbor, MI (US); Ayrton Ackerman, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/037,531

(22) Filed: Jan. 27, 2025

(51) Int. Cl. H01M 50/15

(52) U.S. Cl. CPC H01M 50/15; H01M 2220/20

(57) ABSTRACT

A cover for a battery system is structured to be attachable to a housing of a battery pack to be incorporated into the battery system. The housing contains battery cells and/or a battery module positioned in cavities of the housing. The cover includes thermal event by-product flow reflector(s) extending from the cover above each housing cavity. After initiation of a thermal event in a battery cell/module contained in a housing cavity, by-products of the thermal event flow along the cover toward the by-product flow reflector(s). When the by-products impinge upon the flow reflector(s), the by-products are redirected back toward the housing cavity where the thermal event occurred. This helps protect undamaged battery cells/modules located in adjacent housing cavities from the thermal event by-products. A method of controlling a flow of thermal event by-products in a battery system is also disclosed.

### TECHNICAL FIELD

The present disclosure relates to a cover for a battery system, and more particularly to a battery pack cover structured to direct by products of a thermal event back toward a battery housing cavity in which the thermal event originated.

### BACKGROUND

It is well-known to use electric battery packs for powering electrified vehicles (EV’s). A battery pack may include a housing having an interior divided by walls into multiple cavities. Multiple battery cells or a battery module may be received in each housing cavity. A thermal event (e.g., “thermal runaway” caused by an uncontrollable increase in battery cell temperature) may occur in a battery or module located in a housing cavity. The thermal event generates by-products such as hot gases and particulates. If undamaged battery cells and/or modules are exposed to these by-products, the thermal event may propagate to other portions of the battery pack, potentially causing destruction of the battery pack.

### SUMMARY

In one aspect of the embodiments described herein, a cover for a battery system is provided. The cover includes at least one thermal event by-product flow reflector extending from an associated cavity-overlying surface of the cover.

In another aspect of the embodiments described herein, a method of controlling a flow of thermal event by-products in a battery system is provided. The method includes a step of attaching, to battery pack housing, a battery pack cover incorporating at least one thermal event by-product flow reflector facing in a direction toward an associated battery pack housing cavity including at least one battery cell positioned therein.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. Furthermore, elements may not be drawn to scale. Also, unless otherwise stated or shown, the same or similar elements shown in different views may be given the same or similar reference numerals or designations.

FIG. 1 is a schematic side view of a vehicle including a battery pack incorporating a battery pack cover in accordance with an embodiment described herein.

FIG. 2 is an exploded perspective view of battery pack incorporating a battery pack cover in accordance with an embodiment described herein.

FIG. 3 is a schematic plan view of the battery pack cover shown in FIG. 2.

FIG. 4 is a schematic cross-sectional side view of a portion of the battery pack of FIG. 2, showing the battery pack cover attached to a battery pack housing prior to occurrence of a thermal event in a battery cell/module located in a cavity of the housing.

FIG. 5A is the schematic cross-sectional side view of FIG. 4, shown after initiation of a thermal event in a battery cell/module located in a cavity of the housing.

FIG. 5B is a schematic cross-sectional end view of the housing cavity and portion of the cover shown in FIG. 5A after initiation of the thermal event.

FIG. 6 is a schematic plan view of a battery pack cover in accordance with another embodiment described herein.

FIG. 7 is a schematic cross-sectional side view of a portion of a battery pack showing the battery pack cover in FIG. 6 attached to a battery pack housing prior to the occurrence of a thermal event in a battery cell/module located in a cavity of the housing.

FIG. 8A is the schematic cross-sectional side view of FIG. 7, shown after initiation of a thermal event in a battery cell/module located in a cavity of the housing.

FIG. 8B is a schematic cross-sectional end view of the housing cavity and portion of the cover shown in FIG. 8A after initiation of the thermal event.

FIG. 9 is a schematic side view of a thermal event by-product deposition element in accordance with an embodiment described herein.

FIG. 10 is a schematic side view of a thermal event by-product deposition element in accordance with another embodiment described herein.

FIG. 11 is a schematic side view of a thermal event by-product deposition element in accordance with yet another embodiment described herein.

FIG. 12 is a schematic side view of a thermal event by-product deposition element in accordance with yet another embodiment described herein.

### DETAILED DESCRIPTION

The present disclosure is directed to a cover for a battery system. The cover is structured to be attachable to a housing of a battery pack to be incorporated into the battery system. The battery pack housing may contain battery cells and/or modules positioned in cavities of the housing. When attached to the housing, the cover may environmentally isolate the battery pack contents from an exterior of the battery pack. The cover includes one or more thermal event by-product flow reflector(s) extending from the cover above each housing cavity. Optionally, one or more thermal event by-product deposition element(s) may also be attached to the cover above one or more housing cavities. After initiation of a thermal event in a battery cell/module contained in a housing cavity, by-products of the thermal event flow upwardly toward and impinge upon the cover and the by-product deposition element(s). Particulates from the by-products are deposited on the by-product deposition element(s). The by-products may then flow along the cover toward the by-product flow reflector(s). When the by-products impinge upon the flow reflector(s), the by-products are redirected back toward the housing cavity where the thermal event occurred. This helps protect undamaged battery cells/modules located in adjacent housing cavities from the thermal event by-products. A method of controlling a flow of thermal event by-products in a battery system is also disclosed.

As used herein, the terms “upper” and “above” refer to a vertically relatively higher position or location, and “lower” and “below” refer to a vertically relatively lower position or location, from the perspective of a person standing adjacent a vehicle resting on a ground surface and including a battery pack as described herein mounted in the vehicle in an end-use configuration of the battery pack. In addition, the term “upwardly” refers to movement or flow in a vertically upward direction and the term “downwardly” refers to movement or flow in a vertically downward direction, from the perspective of a person standing adjacent a vehicle resting on a ground surface and including a battery pack as described herein mounted in the vehicle in an end-use configuration of the battery pack.

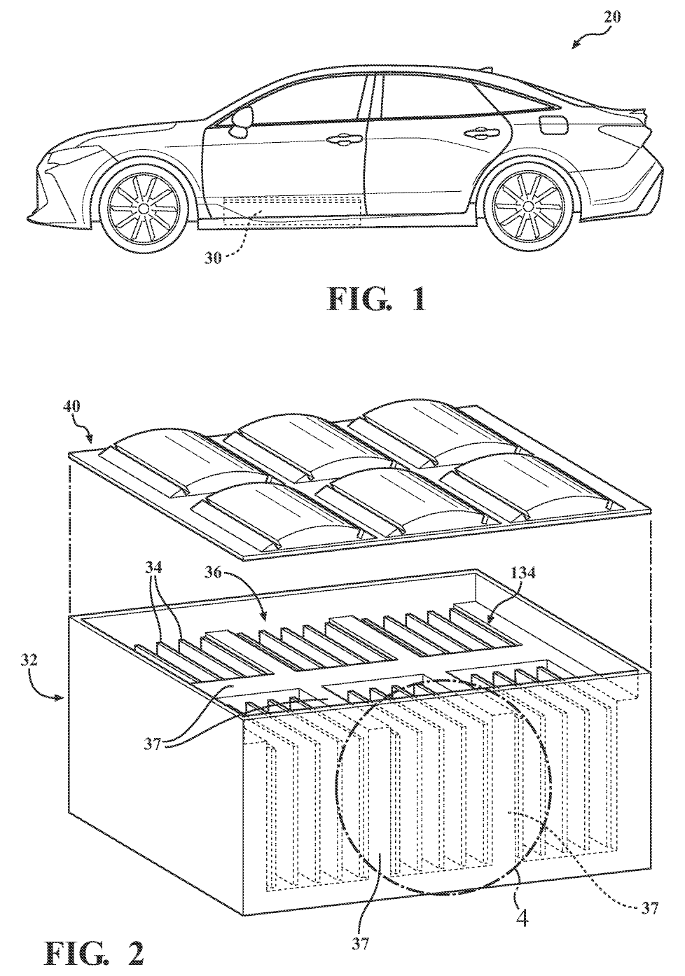

FIG. 1 is a schematic side view of an electric vehicle 20 incorporating a battery pack 30 in accordance with an embodiment described herein mounted in the vehicle 20. The battery pack 30 may be part of a battery system including additional known elements such as an on-board charger (OBC), a battery cooling system, electronic control unit (ECU), power electronics and other elements (not shown) configured for controlling operation of the battery pack 30 and integrating the battery pack with other vehicle systems. In one or more arrangements, the vehicle 20 may be an electric vehicle (EV) and the battery system may be configured to power operation of the electric vehicle.

FIG. 2 is a schematic exploded perspective view of battery pack 30 incorporating an intermediate cover 80 in accordance with an embodiment described herein. The battery pack 30 is a collection of individual battery cells (such as cells 34) and/or battery modules (such as modules 134) arranged in a specific configuration to provide a unified power source. These cells and/or modules may be electrically interconnected in series or parallel configurations and arranged within a protective housing 32 to help ensure safe and efficient operation. The arrangement of cells and/or modules within the battery pack 30 may be designed to optimize performance, capacity, and voltage output for the intended application, so as to deliver reliable and consistent power supply to the other vehicle systems.

In some arrangements, the battery pack 30 integrates components such as battery management systems (BMS), thermal management systems, and safety features (not shown in FIG. 2) to provide a complete power solution for a specific application. Battery packs are commonly used in electric vehicles, energy storage systems, and portable electronics, offering higher voltage, capacity, and energy density than individual battery cells or modules.

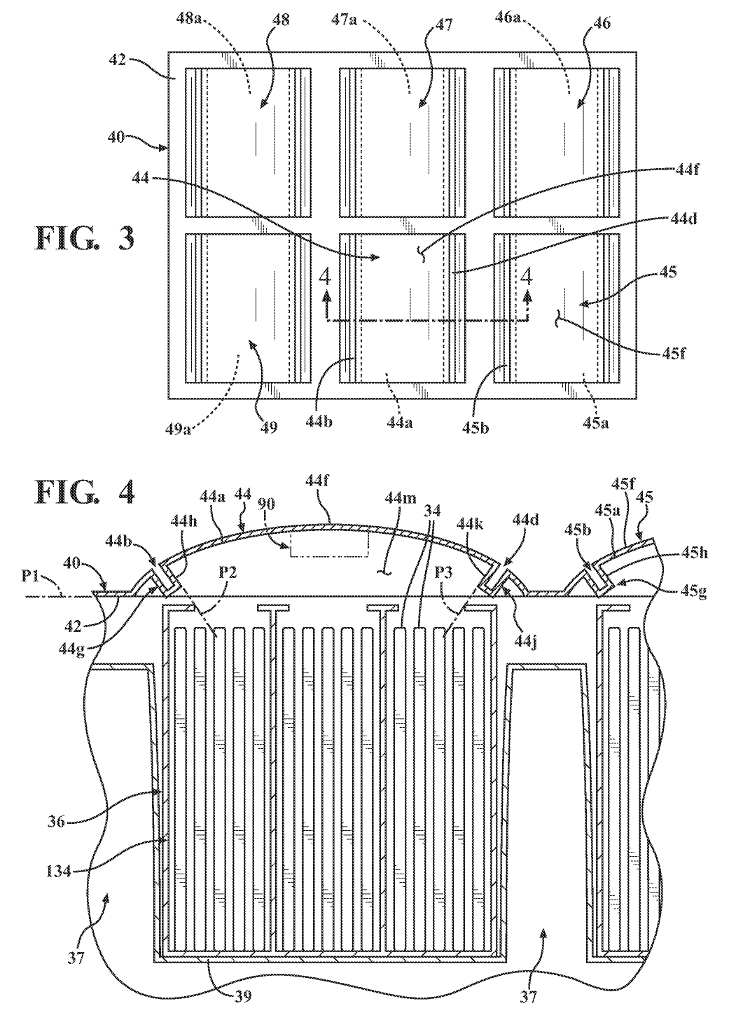

Referring to FIGS. 2 and 3, the battery pack 30 may include housing 32 which is structured to facilitate storage, arrangement, connection, and/or operation of the battery cells 34 and/or modules 134. The housing 32 may include discrete cavities 36 formed therein, with housing walls 37 separating adjacent ones of cavities 36. The cavities 36 may be structured to receive therein the battery cells 34 and/or modules 134 of the battery pack 30. The housing walls 37 may be structured to provide structural support to the battery cells/modules 34/134. The housing walls 37 may also be structured to help environmentally isolate the battery cells contained in each cavity, to aid in preventing by-products of a thermal event occurring in one housing cavity from propagating to battery cells/modules located in one or more other housing cavities.

Referring to FIG. 3, each housing cavity 36 may have an associated opening 36a defined by intersecting uppermost portions 37a of the housing walls 37. The housing 32 may be formed from metallic materials, polymers and/or any other materials suitable for the purposes described herein.

The housing embodiment 32 shown in the drawings includes six housing cavities 36, with each cavity structured to receive therein an associated battery module 134 or an associated grouping of individual battery cells 34. The terms “housing cavity”, “module cavity” and “battery cavity” will be used interchangeably herein to describe a cavity formed in the battery pack housing and structured to receive and store therein a battery module 134 or a grouping of individual battery cells 34.

Referring to the drawings, the battery pack 30 may include a plurality of battery cells 34 arranged in each housing cavity, either individually or as a module 134. The battery cells 34 may be lithium-ion battery cells or other types of battery cells. In some arrangements, the individual battery cells 34 may have prismatic or flat shapes as shown in the drawings. Alternatively, the individual battery cells 34 may be cylindrical or have a known pouch design.

As shown in the drawings, each housing cavity may 36 be structured to receive and contain therein multiple battery cells 34. In some arrangements, the multiple battery cells 34 may be arranged into one or more self-contained battery modules 134. For purposes described herein, a “battery module” is a collection of interconnected battery cells 34 that is positioned within a single cavity 36 of the battery pack housing 32. For example, a grouping of battery cells 34 may be arranged in a module casing 39 structured to contain the battery cells and to be positionable inside an associated cavity 36 in the battery pack housing 32. This enables a group of battery cells 34 to be replaced by extracting the module casing 39 containing the battery cells 34 from the housing cavity 36. The modules 134 can thus be easily replaced or upgraded in the battery pack 30, offering flexibility and scalability in capacity and configuration. The casing 39 may be formed from metallic, polymeric and/or other suitable materials.

To enable and facilitate operation and control of the battery module, each module 134 may also include other elements and/or sub-systems besides the battery cells 34 (e.g., a cooling system, voltage monitoring circuits, etc.) not shown in the drawings. A battery pack 30 may include a plurality of battery modules 134. The battery pack 30 shown in the drawings includes six battery modules 134 which may be electrically coupled in series, parallel, or a combination thereof to power portions of the vehicle 20.

FIG. 2 is an exploded perspective view of battery pack incorporating a battery pack cover in accordance with an embodiment described herein. FIG. 3 is a schematic plan view of the cover shown in FIG. 2. FIG. 4 is a schematic cross-sectional side view of a portion of the battery pack of FIG. 2, showing an exemplary curved cavity-overlying surface of the cover shown in FIG. 3.

Referring to FIGS. 2 and 3, the battery pack 30 may include a battery pack cover 40. The cover 40 may be attachable to the battery pack housing 32 to enclose and protect the battery cells/modules 34/134. The cover 40 may also be structured to seal the battery pack housing 32 and/or otherwise environmentally isolate the battery pack contents from an exterior of the battery pack when the main cover 40 is secured to the housing 32 in its end use configuration. The cover 40 may be formed from a metallic material(s) and/or any other suitable materials.

For purposes of illustration, features of cover embodiments described herein will be discussed in terms of portions of the cover overlying a single housing cavity of a battery pack housing. However, it is understood that the cover features described will also be present in other portions of the cover overlying the remaining housing cavities.

Referring to FIGS. 2-5B, in one or more arrangements, the cover 40 may have a flat base portion 42. The base portion 42 may define a flat plane P1 along an underside thereof. The cover 40 may also include at least one cavity-overlying surface. For purposes described herein, a “cavity-overlying surface” is a surface of the cover structured to overlie (i.e., to reside directly vertically above) an associated battery cavity of a battery pack housing when the cover is attached to the housing in an end-use configuration of the cover (i.e., so that the cover covers and seals the housing).

Each cavity-overlying surface of the cover 40 faces (and is spaced apart from) an associated housing cavity and the battery cells/modules residing in the associated housing cavity. A cavity-overlying surface may be flat or curved in accordance with one of the arrangements described herein. In the embodiment 40 of the cover shown in FIGS. 2-5B, the cavity-overlying surfaces are incorporated into curved portions 44, 45, 46, 47, 48, 49 of the cover 40 as curved surfaces facing into associated housing cavities. The cover 40 includes six curved cavity-overlying surfaces 44a, 45a, 46a, 47a, 48a, and 49a extending from the base portion 42, with one of the curved cavity-overlying surfaces positioned above a respective housing cavity 36 when the cover 40 is attached to the housing.

For example, FIG. 4 is a schematic cross-sectional side view of a portion of the battery pack of FIG. 2, showing an exemplary curved cover portion 44 of the cover 40 shown in FIG. 3. As seen in FIG. 4, the curved cover portion 44 may include cavity-overlying surface 44a facing toward an associated housing cavity 36, and an exterior surface 44f residing opposite the cavity-overlying surface 44a. In some arrangements, the cavity-overlying surface 44a is inwardly-curved (i.e., curved so that a radius of curvature of the surface is positioned in a direction toward the housing cavity with respect to the cavity-overlying surface).

In one or more particular arrangements, the inwardly-curved cavity-overlying surface 44a shown is a concave surface (i.e., a surface having the same radius of curvature at all locations long the surface). In one or more particular arrangements, the inwardly-curved cavity-overlying surface is in the form of a recess formed in the cover 40 and extending from the flat base portion 42 in a direction away from the housing cavity 36.

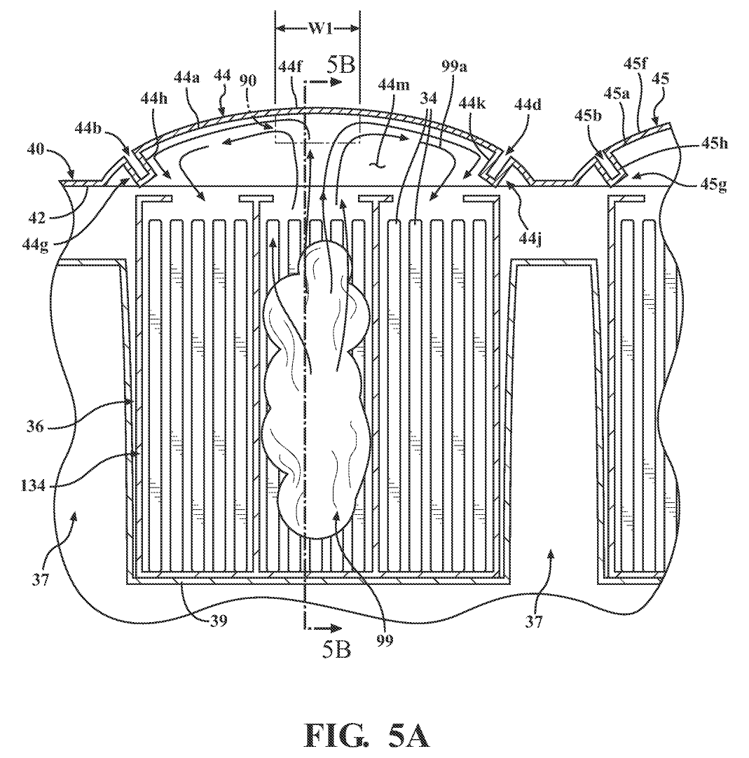

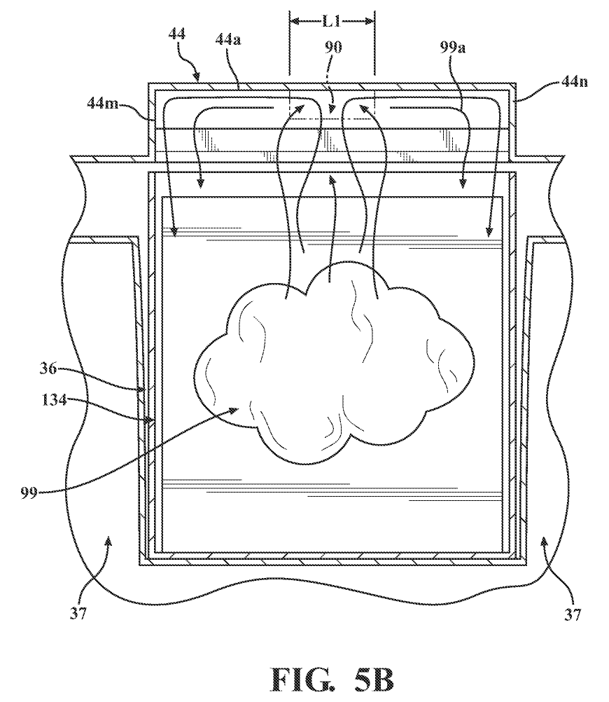

FIG. 5B is a schematic cross-sectional end view of the housing cavity 36 and portion of the cover shown in FIG. 5A. Referring to FIG. 5B, the curved portion may 44 also include opposed end portions 44m, 44n structured to extend vertically from the base portion when the cover 40 is mounted on the housing 32 and the battery pack 30 is installed in the vehicle 20 in its end-use configuration.

Referring to FIGS. 2-5B, each cover curved portion may include at least one flow reflector extending from the respective cavity-overlying surface. As used herein, the term “flow reflector” refers to a feature structured to redirect thermal event by-products impinging thereon in a direction toward an associated originating housing cavity of the by-products, when the cover is secured to an associated housing in an end-use configuration of the cover. An “originating housing cavity” is a housing cavity containing a battery module or battery cell which experienced the thermal event that resulted in generation of the by-products impinging on the flow reflector. Thus, each flow reflector includes at least one reflection surface defining a plane extending into originating housing cavity. For example, the flow reflector 44g shown in FIG. 4 includes a reflection surface 44h defining a plane P2 structured to extend into housing cavity 36.

As described herein, for thermal event by-products originating in housing cavity 36, the surface 44h may be structured to redirect thermal event by-products impinging thereon in a direction toward housing cavity 36. Similarly, the flow reflector 44j shown in FIG. 4 includes a reflection surface 44k defining a plane P3 structured to extend into housing cavity 36. The surface 44k may also be structured to redirect thermal event by-products impinging thereon in a direction toward housing cavity 36.

In one or more arrangements, each cover curved portion may include a pair of opposed, spaced-apart flow reflectors (such as reflectors 44g and 44j in FIG. 4) extending from the cavity-overlying surface. The flow reflectors may be positioned so as to intercept or block thermal event by-products flowing along upwardly from the housing cavity, impinging on the associated cavity-overlying surface, and flowing along the cavity-overlying surface toward adjacent housing cavities. This may prevent or substantially prevent the thermal event by-products from migrating to adjacent housing cavities and triggering thermal events in batteries/modules positioned in the adjacent cavities. “Substantial prevention” of migration of thermal event by-products means prevention of migration sufficient to cause thermal events in any housing cavities other than the originating housing cavity.

Values of parameters such as the dimensions of the flow reflectors, angles of the planes P2 and P3 with respect to vertical planes passing through the housing cavity, and relative positions of the flow reflectors may be determined based on the dimensions and structures of the housing cavity walls, the spacing between the cover and the tops of the housing cavity walls, and other pertinent factors. Values of the pertinent flow reflector parameters needed to prevent or substantially prevent migration of thermal event by-products to adjacent housing cavities may be determined analytically and/or iteratively through experimentation and testing, using methods known or later developed.

In particular arrangements of the cover, as in the example shown in FIGS. 4-5B, each curved cover portion and its respective cavity-overlying surface are formed integrally with the cover, with the associated flow reflectors defined by respective indentations formed along the exterior surface of the respective cover curved portion. For example, as shown in FIGS. 4-5B, curved cover portion 44 and its respective cavity-overlying surface 44a are formed integrally with the cover 40, with the associated flow reflectors 44g and 44j defined by respective indentations 44b and 44d formed along the exterior surface 44f of the respective cover curved portion 44.

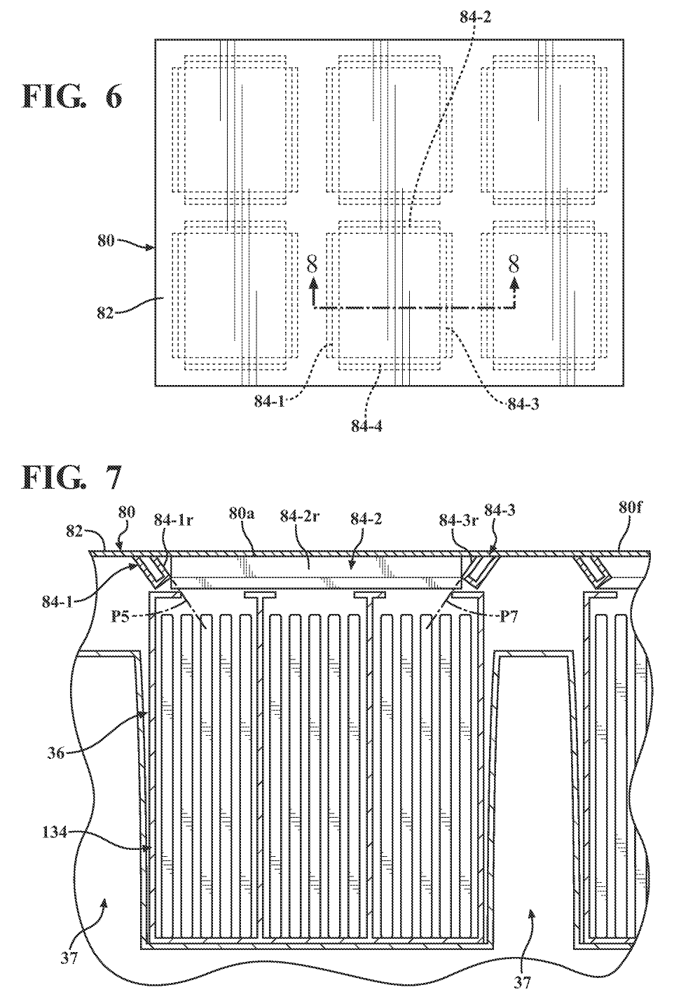

Referring now to FIGS. 6-8B, in an alternative construction 80 of the cover, the cover may have a flat base portion 82 defining at least one cavity-overlying surface 80a facing toward a respective housing cavity 36, and an exterior surface 80f of the cover 80 residing opposite the cavity-overlying surface 80a.

The cover 80 may include a plurality of flow reflectors 84-1, 84-2, 84-3, 84-4 extending from the cavity-overlying surface 80a in a direction toward the housing cavity 36. In this arrangement, each flow reflector may be a part formed separately from the cover 80 and subsequently attached to the cover along the cavity-overlying surface 80a, using mechanical fasteners, adhesives and/or any other suitable attachment method. In this arrangement, each flow reflector may be attached to the cover base portion so as to overlie a respective portion of a perimeter of a housing cavity opening 36a of the respective housing cavity 36. for example, for housing cavities such as cavity 36 having a rectangular opening as shown in the drawings, four flow reflectors 84-1, 84-2, 84-3, 84-4 may be attached to the cavity-overlying surface 80a, with each flow reflector residing above a respective side or edge of the housing cavity opening and with each end of each flow reflector positioned closely adjacent to (or in contact with) an end of another flow reflector.

As seen in FIG. 6, the flow reflectors 84-1, 84-2, 84-3, 84-4 may be attached to the cavity-overlying surface 80aso that each end of a flow reflectors contacts (or lies closely adjacent to) an end of another one of flow reflectors 84-1, 84-2, 84-3, 84-4. Attached to the cavity-overlying surface 80a in this manner, the flow reflectors 84-1, 84-2, 84-3, 84-4 operate to substantially surround or “fence in” the cavity-overlying surface 80a residing above the housing cavity 36. This structure aids in trapping thermal event by-products flowing along the cavity-overlying surface 80a.

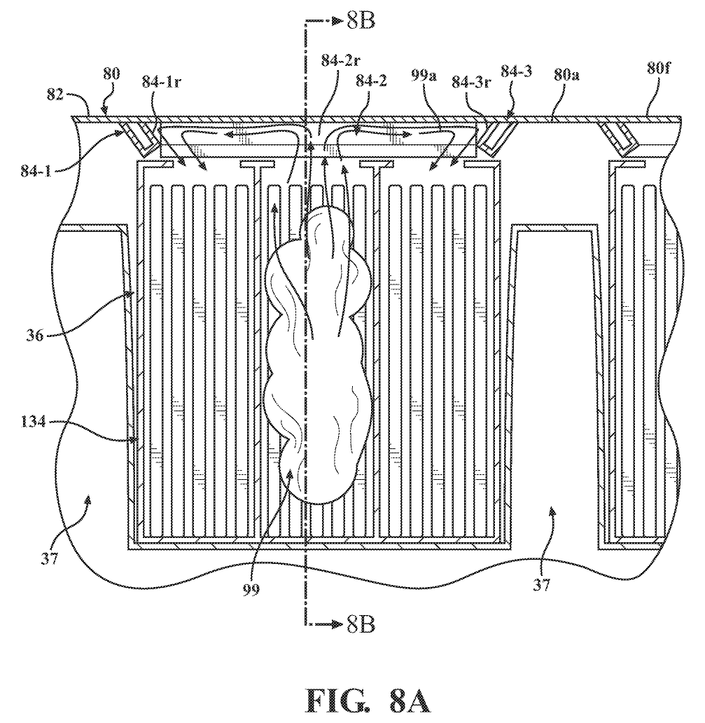

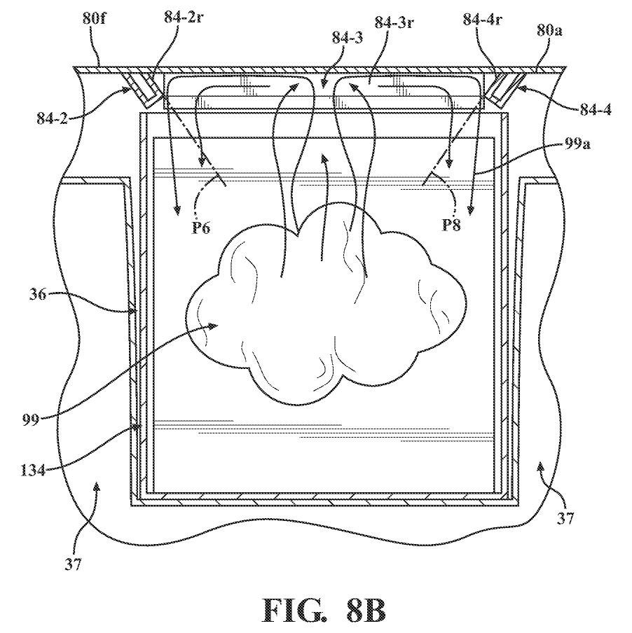

In addition, each flow reflector may include at least one reflection surface defining a plane extending into the originating housing cavity 36. For example, the flow reflector 84-1 shown in FIGS. 7-8B includes a reflection surface 84-1r defining a plane P5 structured to extend into housing cavity 36. Flow reflector 84-2 includes a reflection surface 84-2r defining a plane P6 structured to extend into housing cavity 36. Flow reflector 84-3 includes a reflection surface 84-3r defining a plane P7 structured to extend into housing cavity 36. Flow reflector 84-4 includes a reflection surface 84-4r defining a plane P8 structured to extend into housing cavity 36. In these positions and configurations, the combined flow reflectors 84-1, 84-2, 84-3, 84-4 may be structured to intercept or block thermal event by-products flowing upwardly from the housing cavity 36, impinging on the cavity-overlying surface 80a, and flowing along the cavity-overlying surface toward adjacent housing cavities. This may prevent or substantially prevent the thermal event by-products from migrating to adjacent housing cavities and triggering thermal events in batteries/modules positioned in the adjacent cavities.

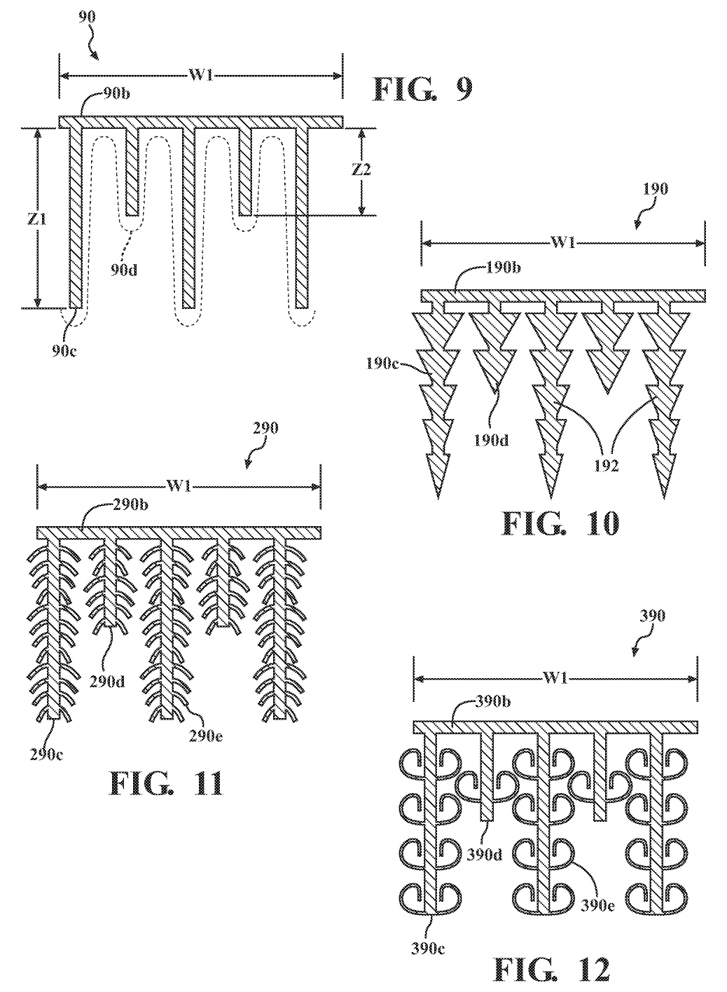

Referring again to FIGS. 4-5B and also to FIGS. 9-12, in some arrangements, the cover may include one or more thermal event by-product deposition element(s) (generally designated 90). Each deposition element may be structured to provide surfaces to which particulates from thermal event by-products may adhere when the by-products come into contact with the deposition element. Contact of the by-products with the deposition element(s) and adherence of particulates to the deposition element(s) facilitates heat transfer from the by-products and entraps potentially corrosive by-product components on the deposition element(s), reducing solids available for migration to other housing cavities and mitigating the damage caused by any migrations.

In one or more arrangements, deposition element structures are directed to maximizing available deposition surface area per unit volume occupied by the deposition element. This aids in maximizing the amount of particulates that can be extracted from the stream of by-products emanating from the housing cavity.

FIG. 9 is a schematic side view of one embodiment of an exemplary deposition element. In embodiments described herein, the deposition element 90 may include a base portion 90b and a plurality of spaced-apart fins extending to alternating distances from the base portion 90b. “Alternating distances” refers to an arrangement where a first fin extends a first distance from the base portion and each fin positioned adjacent to the first fin extends a second distance from the base portion different from the first distance. for example, referring to FIG. 9, it is seen that first ones of fins extending a distance Z1 from the base portion 90b alternate with second ones of the fins extending a distance Z2 from the base portion, where Z1 > Z2. It has been found that this arrangement aids in optimizing the available surface area for by-product deposition.

Each of the deposition element fins may also have an associated body portion. For example, the relatively longer fins of FIG. 9 may have body portions 90c while the relatively shorter fins have body portions 90d. The base portion 90b may have a width dimension W1 and a depth dimension L1 (shown in FIG. 5B, extending perpendicular to a plane of the drawing in FIG. 9-12). the various dimensions of a given deposition element may depend on such factors as the available distance between the deposition element and the battery cells/module in the associated housing cavity, the number of deposition elements to be attached to the cavity-overlying portion of the cover, the desired spacing(s) between adjacent fins, and other pertinent factors. For a given application, deposition element dimensions and spatial arrangements of multiple deposition elements suitable for optimizing deposition of by-products thereon may be determined analytically and/or iteratively through experimentation and testing, using methods known or later developed. In some arrangements, a single deposition element may be attached to an associated cavity-overlying surface. In other arrangements, multiple deposition elements may be attached to an associated cavity-overlying surface.

The deposition elements may be formed from metallic materials, polymers and/or any other materials suitable for the purposes described herein. The deposition elements may be attached to the cavity-overlying surface using mechanical fasteners, adhesives and/or any other suitable method. Because the fins extend to alternating distances from their associated base portion, the fins also extend to alternating distances from an associated cavity-overlying surface when the deposition element base portion is attached to the associated cavity-overlying surface.

Referring to FIGS. 10-12, various alternative arrangements of the deposition elements may include features formed with (or added to) the fin body portions. The supplementary by-product deposition structures may be structured to increase the overall deposition structure surface area available for by-product deposition.

FIG. 10 is a schematic side view of a thermal event by-product deposition element 190 in accordance with another embodiment described herein. The deposition element 190 has a base portion 190b and a plurality of fins with body portions 190c and 190d extending to alternating distances from the base portion 190b. In this arrangement, a plurality of triangular prisms 192 extends from opposite sides of each of body portions 190c and 190d.

FIG. 11 is a schematic side view of a thermal event by-product deposition element 290 in accordance with yet another embodiment described herein. The deposition element 290 has a base portion 290b and a plurality of fins with body portions 290c and 290d extending to alternating distances from the base portion 290b. In this arrangement, a plurality of curved branches 290e extends from opposite sides of each of body portions 290c and 290d.

FIG. 12 is a schematic side view of a thermal event by-product deposition element 390 in accordance with yet another embodiment described herein. The deposition element 390 has a base portion 390b and a plurality of fins with body portions 390c and 390d extending to alternating distances from the base portion 390b. In this arrangement, a plurality of straight branches 390e extends from opposite sides of each of body portions 390c and 390d.

Although the thermal event by-product deposition element embodiments described herein are shown attached to curved cavity-overlying surfaces, such deposition elements may also be attached to flat cavity overlying surfaces, such as surface 80a shown in FIGS. 7-8B.

Operation of the covers 40 and 80 and their respective flow reflectors and deposition elements will now be discussed with reference to FIGS. 4-5B and 7-8B.

FIG. 4 is a schematic cross-sectional side view of a portion of a battery pack showing a cover in accordance with an embodiment described herein attached to a battery pack housing, prior to the occurrence of a thermal event in a battery cell/module located in a cavity of the housing. FIG. 5A is the cross-sectional side view of FIG. 4 showing a flow of thermal event by-products out of the housing cavity after initiation of a thermal event 99 in the housing cavity. FIG. 5B is a schematic cross-sectional end view of the housing cavity and cover portion shown in FIGS. 4 and 5, also showing the flow of thermal event by-products out of the housing cavity after initiation of the thermal event 99.

In the event of a battery cell thermal event 99 in which one or more battery cells experience thermal runaway. For example, the battery cells/modules 34/134 may generate thermal event “by-products” 99a including hot gases and solid debris (e.g. particulates) that may damage other, undamaged battery cells and/or modules if exposed to the by-products. The thermal event by-products 99a may flow upwardly from the housing cavity 36 to impinge on the cavity overlying surface 40a and the thermal event by-product deposition element(s) 90. By-products from the by-product flow may be deposited on the thermal event by-product deposition element(s) 90. after contacting the thermal event by-product deposition element(s) 90, the flow of by-products 99a may spread outwardly along the cavity overlying surface 40a toward flow reflectors 44g and 44j, and also toward vertical end portions 44m and 44n (FIG. 5B). By-products impinging on reflection surfaces 44h and 44k may be redirected along these surfaces back toward the originating housing cavity 36. By-products impinging on vertical end portions 44m and 44n may also be redirected along the end portions back toward the originating housing cavity 36. In this manner, by redirecting the thermal event by-products 99a back toward the originating housing cavity 36, flow of the thermal event by-products is controlled and confined to the originating housing cavity and prevented (or substantially prevented) from migrating to undamaged battery cells/modules in adjacent housing cavities. In addition, the thermal event by-product deposition element(s) 90 may aid in cooling the by-products and removing hot and/or caustic debris from the by-products before the by-products flow outwardly toward other housing cavities.

FIG. 7 is a schematic cross-sectional side view of a portion of a battery pack showing a cover 80 in accordance with an embodiment described herein attached to a battery pack housing, prior to the occurrence of a thermal event in a battery cell/module located in a cavity of the housing. FIG. 8A is the cross-sectional side view of FIG. 7 showing a flow of thermal event by-products out of the housing cavity after initiation of a thermal event 99 in the housing cavity. FIG. 8B is a schematic cross-sectional end view of the housing cavity and cover portion shown in FIGS. 7 and 8A, also showing the flow of thermal event by-products out of the housing cavity after initiation of the thermal event 99.

After initiation of the thermal event, the thermal event by-products 99a may flow upwardly from the housing cavity 36 to impinge on the cavity overlying surface 80a. By-products may also impinge on any thermal event by-product deposition element(s) attached to the cavity overlying surface 80a. The flow of by-products 99a may then spread outwardly along the cavity overlying surface 80a toward flow reflectors 84-1, 84-2, 84-3, 84-4. When the by-products impinge on reflection surfaces 84-1r, 84-2r, 84-3r and 84-4r of respective flow reflectors 84-1, 84-2, 84-3, 84-4, the by-products are redirected or “reflected” back toward the originating housing cavity 36 of the thermal event. In this manner, by redirecting the thermal event by-products 99a back toward the originating housing cavity 36, flow of the thermal event by-products is controlled and confined to the originating housing cavity and prevented (or substantially prevented) from migrating to undamaged battery cells/modules in adjacent housing cavities.

In other aspects described herein, a method of controlling a flow of thermal event by-products in a battery system is provided. The method includes the step of attaching, to a battery pack housing, a battery pack cover incorporating at least one thermal event by-product flow reflector facing in a direction toward an associated battery pack housing cavity including at least one battery cell positioned therein.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of … and ….” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A cover for a battery system, the cover comprising at least one thermal event by-product flow reflector extending from an associated cavity-overlying surface of the cover.

2. The cover of claim 1, wherein the cavity-overlying surface is an inwardly-curved cavity-overlying surface.

3. The cover of claim 2, wherein the inwardly-curved cavity-overlying surface is a concave surface.

4. The cover of claim 2, wherein the inwardly-curved cavity-overlying surface comprises a recess formed in the cover.

5. The cover of claim 1, comprising a pair of opposed flow reflectors extending from the cavity-overlying surface.

6. A battery pack comprising:
a battery pack housing; and
a cover in accordance with claim 1 attached to the battery pack housing.

7. The cover of claim 1, wherein the at least one flow reflector is defined by a part formed separately from the cover and subsequently attached to the cover.

8. The cover of claim 1, further comprising a plurality of spaced-apart fins extending to alternating distances from the cavity-overlying surface.

9. The cover of claim 8, wherein each fin includes a body portion and a plurality of triangular prisms extending from the body portion.

10. The cover of claim 8, wherein each fin includes a body portion and a plurality of curved branches extending from the body portion.

11. The cover of claim 8, wherein each fin includes a body portion and a plurality of straight branches extending from the body portion.

12. A method of controlling a flow of thermal event by-products in a battery system, the method comprising the step of attaching, to a battery pack housing, a battery pack cover incorporating at least one thermal event by-product flow reflector facing in a direction toward an associated battery pack housing cavity including at least one battery cell positioned therein.

13. The method of claim 12, wherein the at least one flow reflector extends from an associated inwardly-curved cavity-overlying surface of the cover.

14. The method of claim 13, wherein the inwardly-curved cavity-overlying surface is a concave surface.

15. The method of claim 13, wherein the inwardly-curved cavity-overlying surface comprises a recess formed in the cover.

16. The method of claim 13, wherein the at least one flow reflector is defined by an indentation formed in a surface of the cover residing opposite the cavity-overlying surface.

17. The method of claim 12, including pair of opposed flow reflectors incorporated into the battery pack cover.

18. The method of claim 12, wherein the at least one flow reflector is defined by a part formed separately from the cover and subsequently attached to the cover.

19. The method of claim 12, further comprising a plurality of spaced-apart fins attached to the cover above the associated battery pack housing cavity and extending to alternating distances from the cover in a direction toward the associated battery pack housing cavity.

20. The method of claim 12, wherein each fin includes a body portion and a plurality of supplementary by-product deposition structures extending from the body portion.
